(19) United States
(12) Patent Application Publication
(10) Pub. No.: US 2002/0066095 A1
(43) Pub. Date: May 30, 2002

(54) Process and device for updating personalized products

(76) Inventor: Yueh-O Yu, Hsinchu (TW)

Correspondence Address: J. C. Patents, Inc., Suite 114, 1340 Reynolds Ave., Irvine, CA, 92614, US

(21) Appl. No.: 09/756,330

(22) Filed: Jan. 8, 2001

(30) Foreign Application Priority Data
May 12, 2000 (TW) 89109105

(51) Int. Cl. G06F 9/445

(52) U.S. Cl. 717/173; 717/172

(57) ABSTRACT

A process for updating personalized products. The process comprises the steps of: downloading a personalized program code or data code from a storage device or a network server. Then, the code is transmitted to a programmable personalized product through a transmission medium. The code received is then programmed into the programmable personalized product, thus the function or information on the programmable personalized product is updated. The above-mentioned personalized program code or data code from the storage device or network server can be provided by the manufacturer or be designed by the user himself Then through a commonly used transmission medium, such as a personal computer, a cellular phone of wireless communication, or other media, the code is transmitted to the programmable personalized product, e.g. a watch, a toy and so on. As a result, the content within the personalized product can be updated at any time through reprogramming. The invention not only enables the function or information of the personalized products to be updated at any time, it also avoids the cost of buying new products to replace the products that becomes quickly outdated. A device in operating the updating process is also provided.

### CROSS-REFERENCE TO RELATED APPLICATION

This application claims the priority benefit of Taiwan application Ser. No. 89109105, filed May 12, 2000.

### BACKGROUND OF THE INVENTION

1. Field of Invention

The present invention relates to a process and a device for updating products. More particularly, the present invention relates to a process and a device for updating a personalized product. The invention uses personalized program code or data code from a storage device or a network server, and programs it on the personalized product through a transmission medium in order to change and update the functions and information on the product.

2. Description of Related Art

FIG. 1 is a diagram that shows the conventional process in designing and selling products. At first, a manufacturer 10 invites an engineer 12 to design a product. The engineer designs the product and sends a sample 14 back to the manufacturer 10 for evaluation. If the sample 14 passes the test, the sample 14 is standardized as a product and thus, mass-produced. Then, the manufacturer 10 provides sales representatives 16 with a batch of the final product to sell to customers 18. If there is a good response to these batch of products, that is, if there is a strong demand by the customers 18, the sales representatives 16 will ask the manufacturer 10 to increase production to meet the needs of the customers 18.

Nowadays, information technology is developing at an increasingly rapid pace, enabling all kinds of electronic devices to be produced to bring great convenience to our lives. However, when there is a fast and heightened demand for updated products, the products produced through the above described process of design and sales cannot immediately respond to the current demand and needs of the customers, and can hardly meet the personalized demand of the people in the present information age. If one follows the above described process in FIG. 1, it would be necessary for the manufacturer 10 to ask the engineer 12 to redesign the product, and then manufacture the improved product again. As a result, not only does the process consume a considerably long period of time, the customers also must consider the fact that they may need to spend a lot of money to buy a whole new electronic device to replace the whole outdated device. And even though the new device is updated, it may still not meet the personal needs of the customers.

Among the conventional technologies, there is a technology disclosed by a patent “A Micro Control Device Having the Function of Programming on Wafer”, Republic of China (publishing number 374883). This technology tries to make use of the function of programming on wafer to solve the problem of incompatibility of computer keyboards, induced by the fact that there are too many kinds of keyboards in the market. However, this technology can only solve fabrication problems of incompatibility caused by a large variety of products. It still cannot provide customers with the service of updating products at any time to suit the changes of personal demands.

Taking another example among the conventional technologies, such as an MP3 player. Although customers can download the MPEG layer 3 music compression file at any time from a network server to listen to the music, this music is also a type of public music having a fixed edition. This music cannot be modified according to personal preference. If ever, additional functions can be included, the entertaining effect can be greatly improved. For example, a customer should be able to replace the voice of the singer with his own voice, or mix the music with his own accompanying music, or even transmit this personalized music back to the network server for others to listen.

### SUMMARY OF THE INVENTION

The object of the present invention is to provide a process and a device for updating personalized products. It enable customers to update at any time the functions and data on electronic devices that they already have, in order to suit the need for personalized products.

Another object of the invention is to provide customers with electronic devices so that they do not have to spend more money in buying the similar device again. In this way, we can reduce the rate of abandoning the hardware of the devices and effectively save the resources of the earth.

Yet another object of the invention is to provide a process and a device for transmitting and updating personalized products through popular transmission media. The way to reach the objective is easy and the device is inexpensive.

A process for updating personalized products is provided according to the present invention, comprising: first providing a storage device to store a personalized program code or data code, wherein the personalized program code or the data code can be provided directly by the manufacturer or produced through the edition and design of the user. A transmission medium is provided to receive the personalized program code or data code and then to transmit the personalized program code or data code to a programmable personalized product so as to update the functions or data on the personalized product.

In addition, a method for updating personalized products is provided according to the invention. The updating method comprises: providing a personalized program code or data code downloaded from a network sever. The personalized program code or data code can be provided directly by the manufacturer or produced through the edition or design by users. A transmission medium is provided to receive the personalized program code or data code and to transmit the code to a programmable personalized product so as to update the functions and data on the personalized product. The connection to the network server described above can be done through a wire or a wireless communication transmission system.

Furthermore, a device for updating personalized products is provided according to the invention. The device is a personalized programmable product, which includes a programmable memory, an input/output interface and a personalized function circuit. The programmable memory can be programmed with a personalized program code or data code through the path of the input/output interface. The personalized function circuit produces personalized functions according to the personalized program code or data code stored in the programmable memory. This device for updating personalized products can also include a control circuit. According to an actual personal design, the control circuit can produce the voltage or control signals used for programming the programmable memory. The control circuit can also deal with the decoding of the personalized program code or the transmission of the personalized data code to the programmable memory.

### BRIEF DESCRIPTION OF THE DRAWINGS

The accompanying drawings are included to provide further understanding of the above descriptions and other objects, characteristics, and advantages of the invention. The drawings illustrate preferred embodiments of the invention and, together with the description, serve to explain the principles of the invention. In the drawings,

FIG. 1 is a diagram showing the conventional process of product design and sales;

FIG. 2 is a flow diagram schematically showing the process for updating personalized products according to a preferred embodiment of the present invention;

FIG. 3 is a diagram schematically showing the process between product design and sales after adopting the process for updating personalized products of the present invention;

FIG. 4 is a diagram schematically showing the method for updating personalized products, according to a first preferred embodiment of the present invention;

FIG. 5 is a diagram schematically showing the method for updating personalized products, according to a second preferred embodiment of the present invention;

FIG. 6 is a diagram schematically showing the method for updating personalized products, according to a third preferred embodiment of the present invention; and

FIG. 7 is a diagram schematically showing the device structure for updating personalized products, according to the preferred embodiment of the present invention.

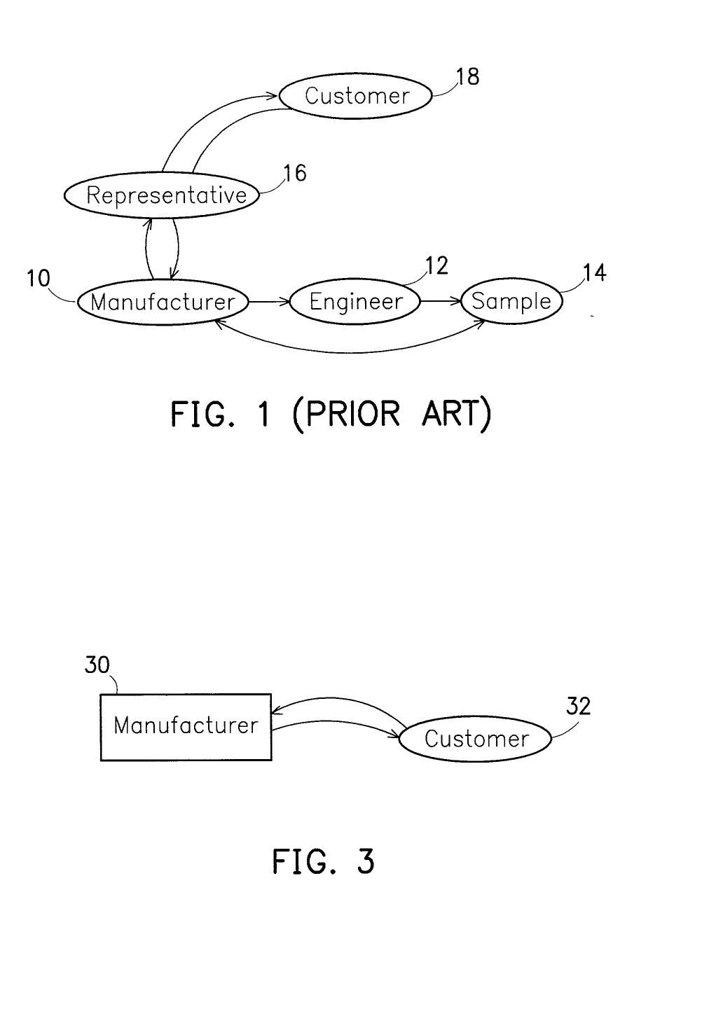

### DETAILED DESCRIPTIONS OF THE INVENTION

The present invention, a process and a device for updating personalized products, is an invention that has an extremely broad application. People in the modern world emphasize individualization of products. They demand that products be updated constantly to suit different moods, different occasions, and different needs in life and so on. However, if, for the purpose of updating, people have to buy a big pile of similar products, it would obviously not be economically beneficial for them.

In describing the invention, we take for example a watch that can tell time and show animation. If we apply the technology of the present invention, we can download a personalized program code or data code at any time from some storage device or a network server, and reprogram the code in the watch. In this way, the watch becomes a new watch that can tell time according to personal daily schedules and that can even tell time with sounds chosen by the individual. Moreover, personalized pictures and animation may also appear on the watch display. A game machine that originally is, for example, used for playing the game of Russian cubes, can be reprogrammed according to personal preference through the personalized program code or data code, so that the mode and color of the dropping cubes and even the rules of the game can be changed. If one does not want to play the game of Russian cubes, one can, for example, change the subject of the game, into a shooting game. Doctor's prescription for patients can also be produced in a form of this kind of personalized program code or data code. The patient's medicine box can be programmed so that it can remind the patient to take medicine, tell doctor's advice to the patient about health care and the common medical knowledge about the disease which the patient is suffering from and so on. These kinds of application cover a very wide range. The categories of products that can use this technology are also all-inclusive. For example, they can be clocks and watches, stationaries, communication devices, religious literatures, health care apparatuses, sports goods, educational appliances, musical instruments, toys and articles for daily use and all other kinds of products. The categories are too numerous to mention individually.

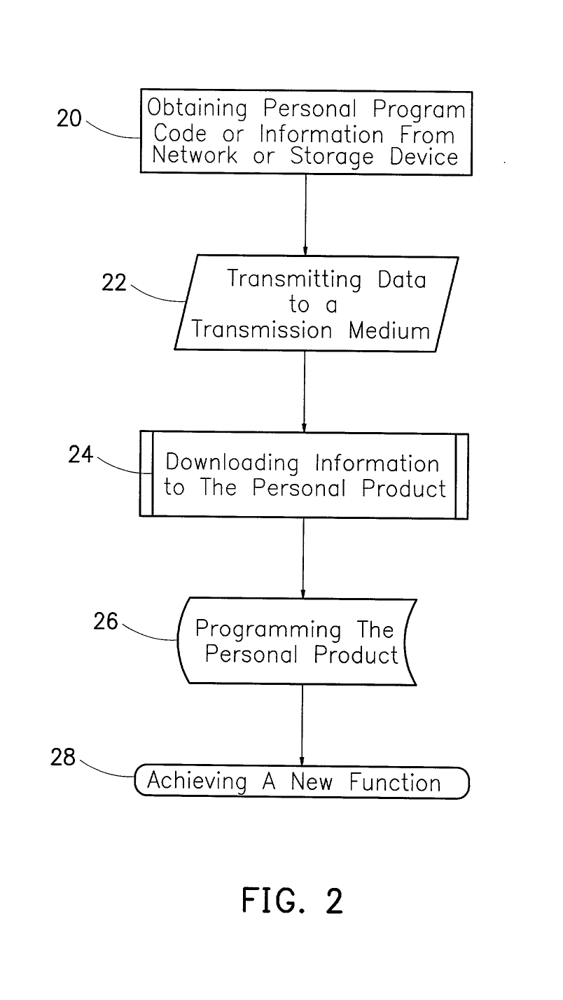

FIG. 2 is a flow diagram showing the process for updating personalized products according to a preferred embodiment of the present invention. At step 20, the user obtains the personalized program code or data code from a network server or a storage device. Afterwards, at Step 22, the personalized program code or data code is transmitted to a transmission medium. The so-called transmission medium can be a personal computer, a personal digital assistant, a cellular phone or any other related device. By making use of the electronic circuit functions possessed by these media, we can save cost by eliminating similar circuit functions on the personalized product, so that the price for the personalized product according to the present invention is lowered.

Then, at Step 24, information is downloaded to a programmable personalized product from one of these transmission media. Next, at Step 26, the personalized program code or data code is written into a programmable personalized product. Finally, at Step 28, the programmed personalized product then is presented with new personalized functions.

In order to further describe the features of the invention, FIG. 3 schematically shows the design and sales process after the method for updating personalized products according to the present invention is adopted. For example, in the diagram, a manufacturer 30 can provide a customer 32 who has a programmable personalized product with all kinds of downloadable personalized program code or data code, that the program code or data code can be produced to suit the all kinds of characteristics or likes of customers on a network server. After the customer buys the product, the customer does not have to change it or buy a new one when he hopes to change some functions or information on the product. All the customer has to do is to get on the network, and then he can have a great variety of choices provided by the network server. Then, the customer can download the updated functions or information that he wants to have, and program it on his programmable product. For example, a grandfather and grandson use the same fitness equipment. When different personalized program codes or data codes are produced according to different ages, heights and habits are programmed in the fitness equipment, the same fitness equipment can be used by the two individuals whose ways of exercise are completely different. In this way, the user saves not only the cost for buying a product, but also the cost of the electronic circuit that originally is designed to be in the personalized product, but is omitted because of the function of electronic circuit possessed by the network server or transmission media.

Apart from this, if when selling the product, the manufacturer can also provide the customer a disk stored with the personalized information according to the customer's needs, and if the manufacturer can also provide development tools so that the customer can develop and design by himself, the effect of the present invention is even more obvious. For example, if the development tool the manufacturer provides is an LCD pattern editor and an LCD simulator, then the customer himself can work on his computer to edit and simulate the LCD pattern on his product. If the development tool the manufacturer provides is a voice development system, then the customer can record his voice by himself and then download it to program on his product. As a result, the need of the customer is fully satisfied and his creativity is put into full play.

There are many ways of providing development systems. For example, a user may design or develop for his own use, or he may be willing to share his achievement in design and development with other people. In the latter case, he may upload his design to the network server for others to download. Also, the manufacturer may arrange a public competition, for example, on the network, using cash prizes to stimulate creativity. This new process for product design and sales saves a lot of time and energy compared with the conventional process in which the development engineer and the sales representative have to repeatedly design and test the products. The new process is also favorable in keeping with the trend for individualization in the modern world. It increases competition and the additional value of products.

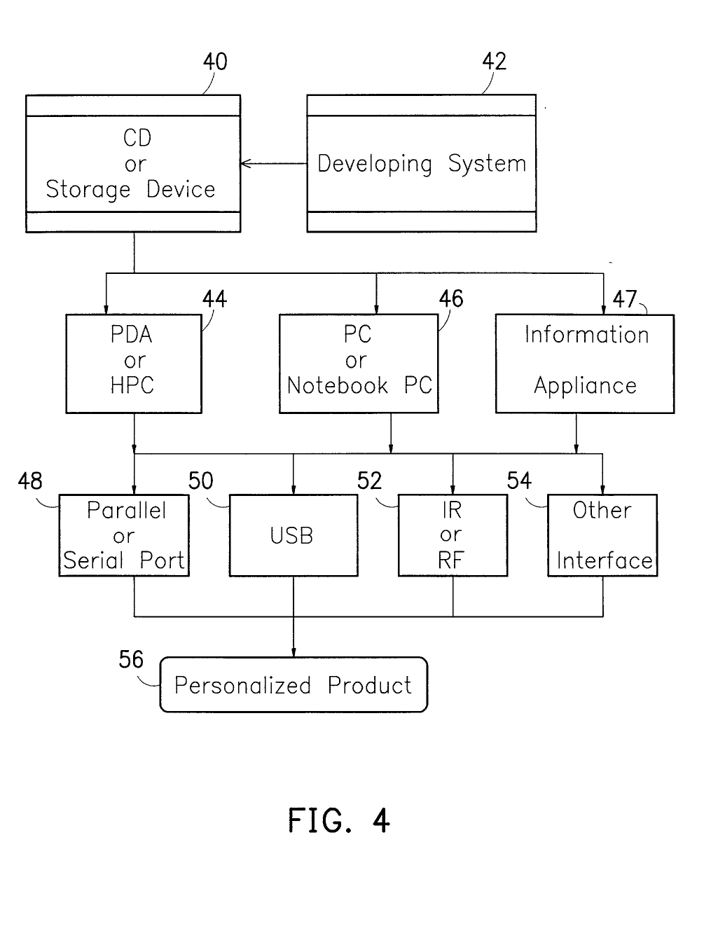

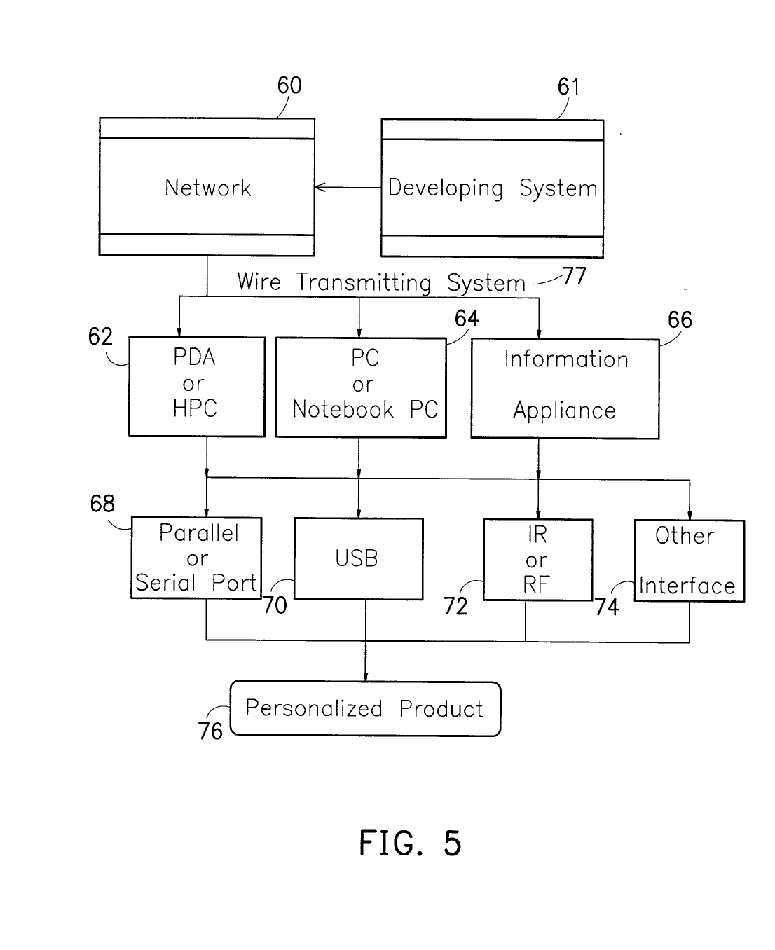

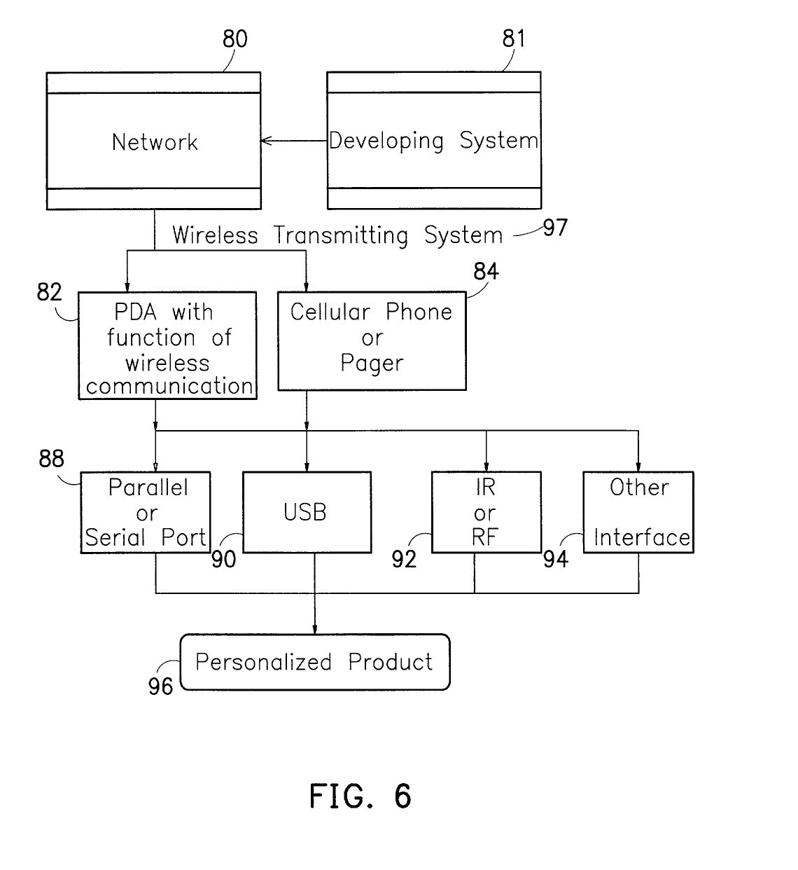

In order to further clearly describe the process for updating personalized products according to the present invention, FIG. 4, FIG. 5 and FIG. 6 schematically show the structure for the first, the second and the third preferred embodiments of the process for updating personalized products according to the present invention. In FIG. 4, a storage device 40 is provided to store the personalized program code or data code. This storage device 40 can be any kind of appropriate device that has a storing function. For example, it can be a Floppy Disk, Hard Disk, Jaz Drive, Zip Drive, CD-ROM, DVD-ROM, CDR-ROM, CDRW-ROM, DVD-RAM, Magneto-Optical Disk, MO, Flash Card, MTP (multi-time programming) Card, Smart Media Card, RAM Card, or magnetic tape and so on.

The customers who want to use a ready-made personalized program code or data code can just choose a ready-made code. Besides, a development system 42 can be provided for the customer to design the product himself This development system 42 can be stored in a storage device (e.g., a disk) and be sold to the customer together with the product. The customer, that is the user then may download the development system 42 to his computer for use. The personalized program code or data code that is to be designed and finished is also stored in this storage device, as designated by the arrow42. Afterwards, the personalized program code or data code is received through a transmission medium and transmitted to a programmable personalized product to update the functions or information on the personalized product. The transmission medium can be a PDA or an HPC 44, a personal computer or a notebook computer 46, a information appliance 47 or any other kind of transmission medium. The interface of the personalized product for the transmission can also be in different forms. For example, a parallel port or a serial port 48, a universal serial bus (USB) 50, an infrared (IR), a radio frequency (RF) 52, or any other self-developed interfaces.

The interface is provided to enable the above described transmission medium to transmit the personalized program code or data code to a personalized product 56. Finally, the code is programmed to produce new functions on the personalized product 56.

Here, we will briefly introduce the above-mentioned form of transmission. The conventional form of transmission is the normal one-way transmission. Whereas, the transmission of the invention is a two-way transmission in the form of EPP or EPC. The serial port is more commonly used, and 3 pins of it can be enough carry out the two-way information transmission. As for USB, version 1.1, the transmission speed is 1.5 Mbs to 12 Mbs. With version 2.0 put forward in 1999, the transmission speed can reach 240 Mbs and it also has the feature of plug & play. As for IR, the price of IR itself is not expensive but it must be used within a range of 1 to 2 meters. It is sensitive to direction, so it must be projected at the right position. And it is limited only to the transmission between two components. These interfaces and forms for transmission should be chosen according to one's personal requirements. If it is necessary, the user can also develop new interfaces for transmission himself.

FIG. 5 shows the architecture of the second embodiment of the process for updating personalized products according to the present invention. In FIG. 5, the main difference between this embodiment and the first embodiment as shown in FIG. 4 is that a network server 60 is provided and stored with personalized program codes or data codes to serve the customers who want to take codes directly. Development system 61 is still provided for users who wish to design their own product. If the development system is designed as a web page, the user online can directly design and develop by connecting with the website. If the development system can be downloaded, the user can download it to his computer to design and develop. The design of the personalized program code or data code finished by the user can be uploaded back to the website, so that the result of the design can be downloaded and used by other user, as shown by reference numeral 61→60 (the result of the design can also be put back to the storage device, as shown in FIG. 4 by reference numeral 42→40). Afterwards, a transmission medium is provided to receive the personalized code or data code and transmit it to a programmable personalized product, so as to update the functions and information on the personalized product. The transmission medium can be any transmission medium, 20 such as PDA, HPC 62, personal computer, notebook computer 64, and information appliance 66. There are also many ways and mediums of transmitting the code to the personalized product. For example, one can choose a parallel port or a serial port 68, a USB 70, an IR or a RF 72 or any other interface 74 developed by the user himself These transmission media transmits the personalized program code or data code to the personalized product 76 and the code is programmed to produce new functions. Ways to connect to the website may include cable transmission system 77. The most common way is to use the Public Switched Telephone Network (PSTN) or we could also employ the integrated service digital network (ISDN), asymmetric digital subscriber loop (ADSL), MODEM, Cable MODEM and so on.

FIG. 6 describes the architecture of the third embodiment of the process for updating personalized products according to present invention. In FIG. 6, as in FIG. 5, the personalized codes or data codes is downloaded from a website 80and a development system 81 is provided. The main difference is that the embodiment in FIG. 6 comprises a wireless transmission system 97 for connecting the website to the transmission medium. At present, there are various kinds of mobile wireless communication systems, for example, the Wireless Application Protocol established by big international companies. In which the WAP is written by a new language WML (Wireless Markup Language) established by the WAP Forum for simplifying the content in the website. Other systems like GSM, CDMA (including W-CDMA and 2000-CDMA), GPRS, 3G (the third generation of wireless communication standard), satellite system and so on can also be used. Then, a transmission medium is provided to receive the personalized program code or data code and to transmit the code to a programmable product, so as to update the functions and information on the personalized product.

The transmission medium can be a PDA 82 that possesses wireless communication functions, a cellular phone or a pager 84, or any other transmission medium that can receive wireless transmission. The interface of the personalized product to which the code is transmitted to can also have different forms. For example, we can choose a parallel port or a serial port 88, a USB 90, an IR or a RF 92 or any other self-developed interface 94. These interfaces enable the above-mentioned transmission media to transmit personalized program code or data code to the personalized product 96 for producing new functions by programming these codes. At present, although some products of the above-mentioned transmission media, like cellular phones, do not have the above-described interface to transmit programmed information, anyone who is skilled in the art can implement the present invention.

The development systems described in FIGS. 4, 5 and 6 enable the users to develop and design by themselves, which is a very convenient way of updating personalized products. Basically, in order to enable ordinary users to access and use the development system more easily, high-level language and employment of user-friendly methods such as drawings, buttons and the point and click system is preferred for in general. As for some program designers or users who like to research and develop programs, low-level language and instruction, and designing methods that require more technical knowledge, can also be provided them to develop a great variety of designs.

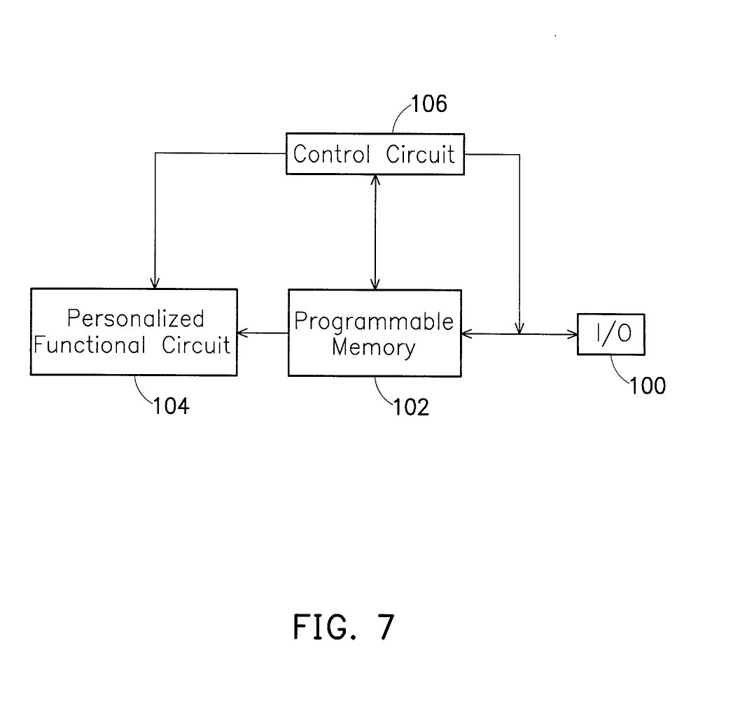

FIG. 7 shows a device for updating personalized products according to the present invention. The device is a programmable personalized product. It includes a programmable memory 102, an input/output end 100 and a personalized function circuit 104. The programmable memory 102 programs personalized program code or data code through the input/output end 100. And the personalized function circuit 104 produces personalized functions based on the personalized program code or data code stored in the programmable memory 102. This device for updating personalized product can also include a control circuit 106. The control circuit is designed according to the need to produce control functions. For example, it can produce the voltage or control signal needed during the programmable memory 102 is being programmed, or it can deal with the decoding of the personalized program code or the transmission of data code in the programmable memory. The control circuit can be a central processing unit (CPU) and the device for updating personalized product can be a micro-controller single chip.

The above-described programmable memory 102 may be EEPROM, Flash memory or MTP, which can change the inner program code or data code at any time. The programming of the changed personalized data code may vary entire data code or a part data code within memory 102; and also the programming of the changed personalized program code may vary entire program code or a part program code within memory 102. Part programming technology can be adopted because the main structure of the program code or data code of some of the personalized products is not reprogrammed with regards to the personalization process.

The application of the device for personalized updating according to the present invention is very broad. The categories of the products are also all-inclusive. For example, they can be clocks and watches, stationeries, communication devices, religious literatures, health care apparatuses, sports goods, educational appliances, musical instruments, toys and articles for daily use and all other kinds of products. The categories are too numerous to mention individually.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for updating personalized products, comprising the steps of:
downloading a personalized program code or a data code from a storage device;
receiving the personalized program code or the data code by a transmission medium, and then transmitting the code to a programmable personalized product;; and
programming the personalized code or the data code received from said transmission medium into said programmable personalized product for updating the function or data therein.

2. A method for updating personalized products according to claim 1, wherein the storage device comprises one selected from a group consisting of a Floppy Disk, a Hard Disk, a Jaz Drive, a Zip Drive, a CD-ROM, a DVD-ROM, a CDR-ROM, a CDRW-ROM, a DVD-RAM, a Magneto-Optical Disk, a Flash Card, an MTP Card, a Smart Media Card, a RAM Card, or a magnetic tape.

3. A method for updating personalized products according to claim 1, wherein the personalized program code or the data code is provided by a manufacturer.

4. A method for updating personalized products according to claim 1, wherein the personalized program code or the data code is developed and provided by a user.

5. A method for updating personalized products according to claim 1, wherein the transmission medium comprises one selected from a group consisting of a personal digital assistant (PDA), a handheld personal computer (HPC), a personal computer, a notebook computer, or a information appliance.

6. A method for updating personalized products according to claim 1, wherein the transmission medium transmits the personalized program code or the data code to the programmable personalized product through an interface selected from a group consisting of a parallel port interface, a serial port interface, a universal serial bus (USB) interface, an IR transmission interface, an RF transmission interface, or a self-developed interface.

7. A method for updating personalized products, comprising:
downloading a personalized program code or a data code from a website;
receiving the personalized program code or the data code by a transmission medium, and then transmitting the code to a programmable personalized product;; and
programming the personalized code or the data code received from said transmission medium into said programmable personalized product for updating the function or data therein.

8. A method for updating personalized products according to claim 7, wherein connection between the transmission medium and the network server comprises at least a wired transmission system.

9. A method for updating personalized products according to claim 8, wherein the wired transmission system utilizes one selected from a group consisting of at least one public switched telephone network (PSTN), at least one integrated service digital network (ISDN), at least one asymmetric digital subscriber loop (ADSL), at least one MODEM, and at least one CABLE MODEM.

10. A method for updating personalized product according to claim 8, wherein the transmission medium is selected from the group consisting of personal digital assistant (PDA), handheld personal computer (HPC), personal computer, notebook computer, and home communication apparatus.

11. A method for updating personalized products according to claim 7, wherein connection between the transmission medium and the network server comprises at least one wireless transmission system.

12. A method for updating personalized products according to claim 11, wherein the wireless transmission system comprises one selected from a group consisting of at least a Wireless Application Protocol, at least a GSM system, at least a CDMA system, at least a GPRS system, at least a third generation wireless communication standard system, at least a satellite system, a personal digital assistant (PDA), a cellular phone, and a pager.

13. A method for updating personalized products according to claim 7, wherein the transmission medium transmits the personalized program code or the data code to the programmable personalized product through an interface selected from a group consisting of a parallel port interface, a serial port interface, a universal serial bus (USB) interface, an IR transmission interface, an RF transmission interface, or a self-developed interface.

14. A method for updating personalized products according to claim 7, wherein the personalized program code or the data code is provided directly by a manufacturer.

15. A method for updating personalized products according to claim 7, wherein the personalized program code or the data code is developed by a user.

16. A device for updating personalized products, comprising:
an input/output end;
a programmable memory, which is programmed with a personalized program code or a data code through the input/output end; and
a personalized function circuit which updates functions and information according to the personalized program code or the data code stored in said programmable memory.

17. A device for updating personalized products according to claim 16, further comprising a transmission medium, wherein the personalized program code or the data code downloaded from either a storage device or a network server is received and transmitted by the transmission medium to the personalized product.

18. A device for updating personalized products according to claim 16, wherein the personalized program code or the data code is provided by a manufacturer.

19. A device for updating personalized products according to claim 16, wherein the personalized program code or data code is developed by a user.

20. A device for updating personalized products according to claim 16, further comprising a control circuit for producing control functions .

21. A device for updating personalized products according to claim 20, wherein the control circuit generates a voltage and a control signal needed during the programmable memory is being programmed.

22. A device for updating personalized products according to claim 20, wherein the control circuit deals with a decoding of the personalized program code in the programmable memory.

23. A device for updating personalized products according to claim 20, wherein the control circuit deals with a transmission of the personalized data code in the programmable memory.

24. A device for updating personalized products according to claim 20, wherein the control circuit comprises a central processing unit (CPU).

25. A device for updating personalized products according to claim 20, wherein the control circuit comprises a micro controller single chip.

26. A device for updating personalized products according to claim 16, wherein the personalized product comprises one selected from a group consisting of clocks, watches, stationeries, communication devices, religious literatures, health care apparatuses, sport goods, educational appliances, musical instruments, toys, articles for daily use, and any other kind of products.

27. A device for updating personalized products according to claim 16, wherein the programmable memory comprises one selected from a group consisting of an EEPROM, a flash memory and MTP.

28. A device for updating personalized products according to claim 16, wherein the personalized program code is a part of a program code within the programmable memory.

29. A device for updating personalized products according to claim 16, wherein the personalized data code is a part of a data code within the programmable memory.
